(19) United States
(12) Patent Application Publication
(10) Pub. No.: US 2015/0245606 A1
(43) Pub. Date: Sep. 3, 2015

(54) EFFERVESCENT TABLET FOR SPRAY DRIFT REDUCTION AND METHOD OF USE

(71) Applicant: VITEL AUSTRALIA PTY LTD, Warrandyte, Victoria (AU)

(72) Inventor: Daniel Drew, Warrandyte (AU)

(73) Assignee: VITEL AUSTRALIA PTY LTD, Warrandyte, Victoria (AU)

(21) Appl. No.: 14/426,871

(22) PCT Filed: Sep. 9, 2013
(86) PCT No.: PCT/AU2013/001023

§ 371 Date: Mar. 9, 2015

(30) Foreign Application Priority Data
Sep. 11, 2012 (AU) 2012903951

(51) Int. Cl. A01N 25/00; A01N 25/34; A01N 57/20; A01N 25/06

(52) U.S. Cl. CPC A01N 25/00; A01N 25/06; A01N 25/34; A01N 57/20

(57) ABSTRACT

A liquid spray additive composition comprising: 5 to 15 wt % of spray drift retardant having particle size of less than 150 micron, and an effervescent couple comprising 15 to 30 wt % acid, and 30 to 50 wt % alkali, wherein the composition is in the form of a tablet.

### FIELD OF INVENTION

The present invention relates to the field of retarding spray drift when a liquid is applied as a spray to a locus. In particular the invention relates to retarding spray drift in applications that require spray application of an active such as an agricultural, horticultural, pharmaceutical, cosmetic or veterinary active.

In one form, the invention relates to a composition for dosing of spray drift retarding agents.

In one particular aspect the present invention is suitable for use in the formulation of spray liquids.

While the present invention will be described with particular reference to spray drift control for agricultural or horticultural formulations, it should be appreciated that the present invention is not so limited and can be used for other applications including industrial and medical/veterinary applications.

Furthermore, while the present invention will be described with particular reference to visco-elastic polyacrylamides (PAMs) as spray drift retardants, it should be appreciated that the present invention is not so limited and can be used with other spray drift retardants including, but not limited to, polyethylene oxides, poly(vinyl pyrrolidones), guar-gum compounds, soy lecithin compounds, and cellulosic materials such as carboxymethyl cellulose.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Spray Drift:

Many liquids are applied to a locus in the form of a spray. Spray application processes are used in many industrial applications such as aerial fire fighting, dust control, gas scrubbing, crude oil spill treatments and agricultural, applications such as treating crops with bio-actives. These sprays are typically discharged from moving vehicles such as aircraft, tractors, ground rigs or railcars.

One of the problems associated with spray application is ‘spray drift’ which occurs when mist or fine droplets of spray do not reach the intended target. Spray drift is the physical movement of spray droplets (and their dried remnants) through the air from the spray applicator nozzle to any off-target site at the time of application or soon thereafter. Where used herein, the term ‘spray drift’ does not include secondary movement of spray components to off-target sites due to volatility, erosion, surface or groundwater transport or wind transport of particles that occurs after spray application.

The off-target material is typically ineffective; wasted and constitutes an economic loss. In agricultural applications, the bio-actives and other chemicals in spray drift can be of environmental concern if they cause air or water pollution, potentially causing hazards for crops, water supplies and livestock in the vicinity of the target. Farmers and agricultural chemical suppliers are becoming increasingly aware of the problems associated with spray drift. Furthermore agricultural and environmental authorities are tightening regulation relating to spray drift management.

Spray Drift Control Agents:

Spray droplet size is a major factor affecting drift. While small droplets provide better coverage of a target, they are more susceptible to drift than larger droplets. Efforts have been made in the past to reduce spray drift by improving spray equipment design, such as, for example, altering nozzle design to optimise spray patterns, or optimising application parameters such as spray pressure, heights, shrouds and formulations. One of the more promising formulation improvements has been the use of droplet size range modifiers called ‘drift control agents’.

Effective drift control agents preferably have as many as possible of the following characteristics:
cause increase in small droplet size,
are insensitive to high shear in the spray system,
do not detract from the performance of spray bio-actives,
are compatible with other spray adjuvants,
do not separate upon standing,
are easy to store, handle and use,
are environmentally friendly, and
are cost efficient.

Spray drift control agents are typically high molecular weight polymers which, tend to increase the viscosity of aqueous systems and thus prevent the water from being broken up into a fine mist when sprayed. For example, visco-elastic polyacrylamides (PAMs), polyethylene oxides and poly(vinyl pyrrolidones), guar-gum compounds, soy lecithin compounds, and cellulosic materials such as carboxymethyl cellulose are typical spray drift control agents.

In particular, normal practice is to mix the polymer as a powder, aqueous, viscous concentrate or reverse phase emulsion with water (eg in a spray tank) so as to form an aqueous solution of polymer. However, aqueous polymer concentrates and, emulsion polymers can be difficult to activate in this situation and polymer powders take a long time to dissolve.

While linear PAMs are well known as drift retardant agents, they also have some characteristics that make them difficult to use, such as being very difficult to dissolve in water, often taking several hours to fully hydrolyse. Australian patent AU 2002311857 (Wallace & Arnold) notes that rapid water solubility can be achieved using particle sizes of <150 micron. However such small particles tend to agglomerate in water to form clumps or gels which must be broken up to facilitate hydrolysis. Water quality sensitivity can also affect the rate of dissolution. Accordingly, specific organic inverting surfactants are often used with these polymers to enable them to be properly hydrated and dispersed in water. As a consequence in agricultural applications, they are only available to farmers as viscous liquid concentrates which are very difficult to measure handle and mix. In addition PAMs are sometimes distributed as an emulsion in a kerosene carrier which limits the dispersibility and additionally presents a volatile organic component problem for end users. As a result of these difficulties farmers are reluctant to use PAM concentrates.

One of the problems associated with drift control agents of the prior art is that they can be difficult to incorporate into a spray liquid, particularly aqueous spray. The spray actives are usually supplied to farmers as a concentrate that must be diluted with water to form a sprayable composition.

In order to avoid metering difficulties associated with spray drift agents and other additives, it is often preferable to mix the additive with a known volume of water or aqueous composition fed to the spray pumps. It is particularly preferred to use tableted spray drift agents because they are easier to store, more convenient to handle and simpler to measure than liquids.

For example, U.S. Pat. No. 7,550,156 describes rapidly disintegrating tablets containing across linked PAM as a disintegrant to aid release of actives. Cross-linked PAM swells when it absorbs water to rapidly break up the tablet, but does not generally dissolve. Australian patent application 2007204954 discloses water-dispersible, pesticide containing granules comprising at least one amphiphilic polymer. When diluted with water it forms a dispersion, but does not dissolve. Because the polymers disclosed in these prior art documents do not dissolve, the solutions typically need to be stirred or otherwise mechanically agitated to ensure a consistent distribution of polymer particles throughout the formulation.

Accordingly there is a need for a spray drift agent that can be readily incorporated into a liquid to form an even concentration throughout the spray liquid.

### SUMMARY OF INVENTION

An object of the present invention is to provide a readily dissolvable solid dosage form of spray drift agent.

Another object of the present invention is to provide a solid dosage form of spray drift agent that can be readily metered.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a liquid spray additive composition comprising:
5 to 15 wt % of spray drift retardant having particle size of less than 150 micron, and
an effervescent couple comprising 15 to 30 wt % acid, and 30 to 50 wt % alkali,
   wherein the composition is in the form of a tablet.

The tablet typically also includes 10 to 15 wt % of tableting aids.

Preferably the spray drift retardant is a polymer formed from water soluble monomer or monomer blend, usually water soluble ethylenically unsaturated monomer. The polymer may be cationic or amphoteric but is preferably non-ionic or anionic. Particularly preferred polymers are non-ionic polymers or anionic polymers containing up to 30 wt % anionic monomer components. In a preferred embodiment the spray drift retardant is chosen from the group comprising visco-elastic polyacrylamides (PAMs), polyethylene oxides, poly(vinyl pyrrolidones), guar-gum compounds, soy lecithin compounds, cellulosic materials such as carboxymethyl cellulose and mixtures thereof. In a particularly preferred embodiment the spray drift retardant is a linear PAM or mixture of linear PAMs.

In a particularly preferred embodiment of the invention described herein there is provided a liquid spray additive composition comprising:
9 to 11 wt % of at least one PAM and having particle size of <150 micron,
an effervescent couple comprising 27 to 29 wt % organic acid, and 49 to 51 wt % sodium or potassium bicarbonate,
9 to 11 wt % polyethylene glycol, and
1 to 3 wt % of one or more tableting aids, such as a release agent,
   wherein the composition is in a solid dosage form such as a tablet or filled, soluble capsule.

PAM:

In a particularly preferred embodiment the spray drift additive comprises one or more PAMs. Polyacrylamide (also referred to as poly(2-propenamide) or poly(1-carbamoylethylene)) is a polymer (—CH₂CHCONH₂—) formed from acrylamide. Almost any linear PAM (non-ionic, anionic, cationic) can be tableted. However, if the tablet is to be used in an agricultural or horticultural spray it should be noted that the ionic PAMs are incompatible with some agrochemical ingredients. Accordingly, the PAM used for these applications should be non-ionic (eg acrylamide homopolymer) or have 30% or less, more preferably 5% or less of ionic character, and a molecular mass of 15 to 20 million. Ionically balanced polyacrylamide formulations may also be used.

The solid particles of spray drift agent use in the additive formulation may be manufactured by any convenient means known to those skilled in the art. For example the manufacture may include the use of fluid-bed dryers or vacuum granulators. Sieving, crushing or grinding may be required to reduce the solid particles to the desired size.

In one embodiment of the present invention the tablet includes both low molecular weight PAM and high molecular weight PAM. Alternatively, it is possible to combine in aqueous solution, one or more tablets having low molecular weight PAM with one or more tablets having high molecular weight PAM. U.S. Pat. No. 5,525,575 (Chamberlain) suggests that low molecular weight PAMS added to a sprayable systemic active ingredient may enhance systemic activity, but only discloses the use of low molecular weight PAMs to aid absorption of active into foliage.

Effervescent Couple:

The effervescent couple serves to provide localised agitation to facilitate hydration and prevent the small PAM particles from Clumping to form gel agglomerates. Effervescent couples are well known for oral delivery systems in the pharmaceutical and dietary industries. Effervescence is the reaction (in water) of acids and bases to produce carbon dioxide.

Preferably the acid of the effervescent couple is an organic acid such as citric, malic, ascorbic, adipic, tartaric and fumaric acids or other food acids or combinations thereof.

Preferably the alkali of the effervescent couple is a potassium or sodium carbonate or bicarbonate.

Additives:

The additives are typically tableting and solubilising aids well known to those skilled in the art. They may for example include tableting aids such as press-release agents). A binder may be added to bring the tablet hardness to a desirable level for handling, but must leave it soft enough to disintegrate in solution. A binder should be water soluble and typically includes dextrose, sorbitol, xylitol and lactose. Any press lubricant used is preferably water soluble, and includes for example, polyethylene glycol (6000 to 12000), sodium benzoate and adipic acid. Some tablet presses that use lubrication spray on the punches do not require lubrication in the formulation.

Other additives may be utilised to improve other properties of the spray solution and may include, for example, anti-foaming agents.

The present invention is typically provided in a solid dosage format such as a tablet or filled, dissolvable capsule or pillow.

Tablet:

Where used herein the term ‘tablet’ is intended to include any solid formulation including, but not limited to, pellets, bricks, bars, granules, prill or blocks and also agglomerated materials which form as a result of solid material sticking together during storage, especially under high humidity conditions. Tablets can be produced by the direct compression or compression after granulation techniques. Both these tableting techniques are well known to those skilled in the art.

The tablets may be manufactured by any convenient means known to those skilled in the art. For example, effervescent granulations can be mixed in conventional blending equipment such as ribbon, twin-cone and V-type blenders. Fluid-bed dryers have been used for many years to make effervescent granulations and include the step of spraying, water or binder solution onto an effervescent mixture while it is suspended in a stream of hot, dry air. In an alternate process water or binder solution is sprayed onto an effervescent mixture during blending, and a vacuum granulator is used to apply vacuum and heat to the mixture. Effervescent products normally require tablet presses that deliver high compression forces and are kept under strictly controlled temperature and humidity up to the point of packaging.

It is envisaged that the effervescent tablets will be packaged in protective packaging such as foil or composite polymer sealed wrapping. Water-soluble polymer film wrap may also be employed to provide a moisture barrier yet be dissolvable when the tablet and polymer wrap are added to water.

Spray Formulation:

The tableted spray drift retardant of the present invention may be incorporated into any desired spray formulation.

In a further aspect of embodiments described herein there is provided a spray formulation comprising:
a spray drift tablet according to the present invention,
a carrier solvent,
an active.

In a preferred embodiment the active is chosen from agricultural, horticultural, pharmaceutical or veterinary actives, or combinations thereof.

Typically the carrier solvent will be water, or an aqueous solution.

The tablets of the present invention may be of any convenient size for the application. For example, a tablet of approximately 4.5 g may be useful for dropping into the 15 to 20 litre tank of a knapsack sprayer, while a 30 g tablet may be more convenient for the 100 litre tank of a mobile sprayer. For large mechanised spray systems, a 150 g tablet could be used for each 500 litres of tank fluid. The Large, 150 g tablets could also be used in water treatment, water/solids separation and all other applications for large volumes of liquid that require PAMS.

Thus the tablets of the present invention can be rapidly dissolved for example when the spray tank is filling with water. Dissolution time is typically 3 to 8 minutes.

The tablets of the present invention can be prepared not only with PAM drift retardant, but also may contain other additional active ingredients that are affective at low concentrations. Systemic pesticides such as imidocloprid or growth promoters such as gibberellic acid are active at very low concentrations in a spray solution and so may be included in an effervescent tablet formulation without compromising the relative proportions of other ingredients.

In another aspect of embodiments described herein there is provided a method of forming a spray formulation comprising the step of adding one or more tablets according to the present invention to an aqueous spray solution, wherein the PAM concentration is 10 to 200 mg per litre of spray solution, preferably 10 to 80 mg, or more preferably 30 to 60 mg per litre of spray solution. In general, aerial spraying operations require the higher PAM concentrations (as high as 200 mg per litre of spray solution). Ground-level spray applications, such as those using a boom, require lower PAM concentrations, typically from 10 to 80 mg per litre of spray solution. The required concentration of PAM can be readily achieved by addition of the appropriate number of tablets.

In yet a further aspect of embodiments described herein there is provided a method of forming a liquid spray formulation comprising the step of adding a tablet according to the present invention to a carrier solvent. Typically the solvent will be a body of water in a spray tank.

For example for agrochemical applications, the method of forming a spray liquid formulation will comprise the steps of:
(i) providing a tablet according to the present invention,
(ii) providing a concentrate containing an agrochemical active,
(iii) forming the spray liquid by combining the tablet and concentrate with a solvent.

Other components such as wetting agents may be added to the solvent.

Typically the agrochemical active is a herbicide, pesticide, fertiliser, growth promoter (such as a plant hormone) or other crop protection active.

Typically, when the agrochemical active is water-soluble it is supplied by the manufacturer as an aqueous concentrate. Preferred water-soluble pesticide/herbicide actives include glyphosate, glufosinate, chlormequat, diquat, paraquat, clopyralid and hormone weedkillers such as Mecoprop, 2,4-D, CMPP or MCPA for instance as a potassium, sodium or amine (preferably isopropyl amine) or other water soluble salt.

The active may alternatively be supplied in another conventional form, such as oil in water emulsion, suspension concentrate and water dispersible grains.

Water insoluble pesticide/herbicide actives include Bromoxynil. Ioxynil and Pentanochlor. Others include Fenoxaprop-ethyl oil in water emulsion, Quizalofop-ethyl suspension concentrate, Fluroxypyr emulsifiable concentrate, Metsulfuron-methyl water dispersible granules and Isoproturon suspension concentrate.

Wetting Agents:

Spray formulations often include wetters to promote wetting of and spreading by dramatically reducing surface tension. When applied to plants, wetting agents dramatically reduce droplet contact angle thus providing for greater surface coverage, stomatal penetration and agrochemical efficacy. In agricultural and horticultural applications wetting agents are used to promote adhesion of the spray droplets to hydrophobic surfaces of plants, and the better uptake of actives through penetration of cuticular waxes. A larger amount of active ingredient passes onto and into the plant and the active functions more effectively, even under adverse conditions of dusty, hairy or hard to wet plants. Optimally, the spray drift retardant of the present invention in combination with a wetting agent will work synergistically to enhance the beneficial properties of both agents.

In another aspect of the present invention there is provided a spray formulation additive comprising a spray drift retardant tablet according to the present invention and a non-ionic wetting agent.

In this application, the spray drift tablet is in the form of granules and suspended in the non-ionic wetting agent. The surfactant must be a 100% active ingredient with no associated water, such that the PAM remains in the solid state in suspension. Preferably the PAM will be present at between 1 and 80 wt %, more preferably 10 to 30 wt %.

The wetting agent may be chosen for example, from so called super-wetting tri-siloxanes or surfactants traditionally used for this purpose. The combination of spray drift retardant tablet with wetting agent may dramatically reduce the amount of wetting agent needed for optimum performance by up to 70 or 80%. For example if 200 ml/ha is normally used in a spray formulation, only 40 ml/ha is required when the spray drift retardant tablet of the present invention is combined, thus leading to economic savings and improved safety because less surfactant is applied to plants. Concomitantly, spray volume can be reduced by up to 30 to 50% saving time, money and environmental resources.

Ideally the suspension of wetting agent and spray drift tablet is packaged into water-soluble sachets or pods, such as can be manufactured from polyvinyl alcohol, similar to commercially available machine fabric washing surfactants. The relative proportions of wetter, polyacrylamide and pod mass is determined by the recommended quantity of water.

Other aspects and preferred forms are disclosed in the specification and/or defined in the appended claims, forming a part of the description of the invention.

In essence, embodiments of the present invention stem from the realization that PAMs hitherto considered difficult to use can be provided in a dosage form that is convenient to store, handle, dissolve and meter. Without wishing to be bound by theory it is believed that the tablet formation of the present invention overcomes the difficulties of PAM dissolution and dispersion by effectively keeping the particles separated, reducing the likelihood of agglomeration. The separation of particles is facilitated by the agitation caused by effervescence. Again, without wishing to be bound by theory it is believed that the addition of surfactant to tablets of the present invention is particularly desirable because individual particles become surrounded by surfactant molecules, resulting in repulsive forces keeping the particles separated.

Advantages provided by the present invention comprise the following:
minimises spray drift, thus reducing the possibility of off-site environmental damage;
contributes to compliance with regulations governing chemical handling and spray drift containment;
more efficient use of chemicals in economic terms, and in terms of quantity;
easy to store, handle, dissolve and meter;
complete dissolution of the spray drift active avoids retention of residue in tanks, lines, filters and nozzles avoiding reduction in spray efficiency and minimising system cleaning and maintenance.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 is a plot of volume median diameter (Dv50) against droplet size for all treatments obtained for the AIXR-11002 nozzle;

FIG. 2 is a plot of the percent driftable droplets (<100 micron) against volume % for the AIXR-11002 nozzle;

FIG. 3 is a plot of volume median diameter (Dv50) against droplet size for all treatments obtained for the TT-11002 nozzle;

FIG. 4 is a plot of the percent driftable droplets (<100 micron) against volume % for the TT-11002 nozzle;

FIG. 5 is a plot of volume median diameter (Dv50) against droplet size for all treatments obtained for the XR-11002 nozzle;

FIG. 6 is a plot of the percent driftable droplets (<100 micron) against volume % for the XR-11002 nozzle;

FIG. 7 is a plot of spray droplet volume distribution for the XR-11002 nozzle when 30 ppm of the present invention and 30 ppm of Akzel-R-ate™ are present;

FIG. 8 is a plot of spray droplet volume distribution for the XR-11002 nozzle when 60 ppm of the present invention and 60 ppm of Akzel-R-ate™ are present.

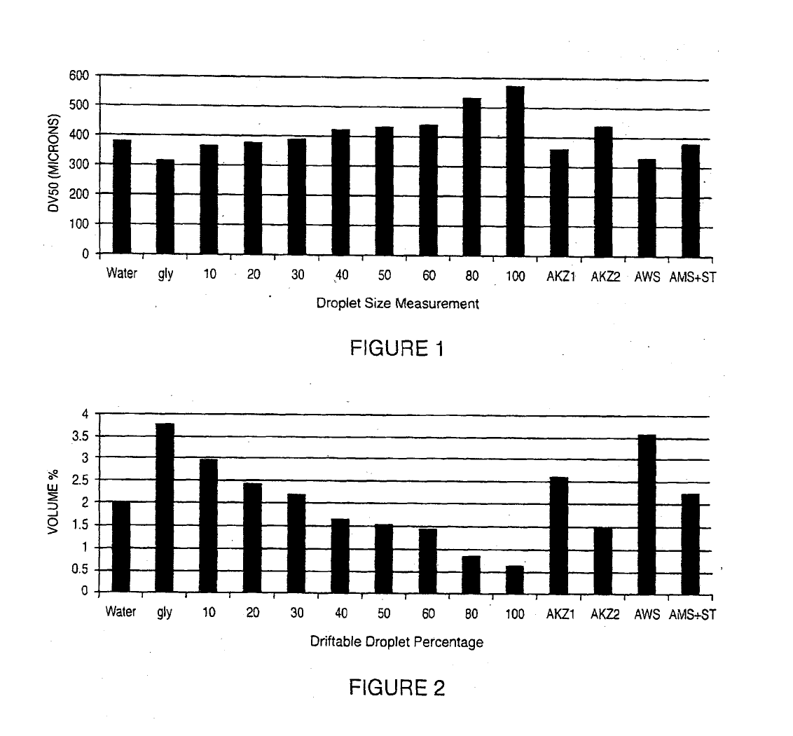

### DETAILED DESCRIPTION

The present invention will now be described with reference to the following non-limiting examples. Where indicated on the FIGS. (1) refers to 2% glyphosate only; (2) refers to the present invention at (a) 30 ppm or (b) 60 ppm; and (3) refers to Akzel-R-ate at (a) 31 ppm and (b) 62 ppm.

### Example 1

### Spray Droplet Size Testing of Spray Drift Retardant

Thirteen mixtures comprising the agrochemical active Glyphosate (450 g/l) and a water-only control were sprayed through three different nozzle types (AIXR11002, TT11002, XR11002) at a selected spray pressure of 300 kPA. In the following example, where reference is made to formulations of the present invention, this is intended to refer to a formulation comprising spray drift formulation of:
non-ionic PAM (<150 micron particle size)—10 wt %
press release agent—2 wt %
polyethylene glycol 6000—10 wt %
citric acid—28 wt %
sodium bicarbonate 50 wt %
   The measurements are summarised in Table 1:

TABLE 1
Droplet size measurement test program

| | Concentration of product | | | | | |
|---|---|---|---|---|---|---|
| | | | Present | | | |
| Mix | | Herbicide | invention | Akzel-R- | AMS | Pressure |
| No. | | (% v/v) | (ppm) | ate ™ | (g/l) | (kPa) |
| 0 | Water | — | — | | | |
| | only | | | | | |
| 1 | | 2 | — | | | 300 |
| 2 | | 2 | 10 | | | 300 |
| 3 | | 2 | 20 | | | 300 |
| 4 | | 2 | 30 | | | 300 |
| 5 | | 2 | 40 | | | 300 |
| 6 | | 2 | 50 | | | 300 |
| 7 | | 2 | 60 | | | 300 |
| 8 | | 2 | 80 | | | 300 |
| 9 | | 2 | 100 | | | 300 |
| 10 | | 2 | | 31 | | 300 |
| 11 | | 2 | | 62 | | 300 |
| 12 | | | | | 1.1 | 300 |
| 13 | | | 30 | | 1.1 | 300 |

The mixes with Akzel-R-ate™ were made by adding a measured mass of product and calculating the PAM concentration by taking into account the measured density of the concentrate. Thus, the two rates tested approximate the low and high label rates: Akzel-R-ate™ (also sold as Companion Gold™ in some countries) is a well known commercially available spray drift retardant of the prior art from Ciba Specialty Chemicals (now BASF).

A Sympatec laser diffraction analyser was used in the wind tunnel research facility to measure the droplet spectra for each of the treatments. Three replicate measurements were made for each treatment. The spectra were measured close to the nozzle but after full droplet breakup (˜150 mm) in a 7.5 m/s (27 km/hr) air stream. The ‘driftable fines” (% vol <100 micron and <150 micron) were determined for each of the treatments.

The 10%, 50% and 90% spray volume diameters (Dv10, Dv50 and Dv90) were also calculated for each of the treatments. The Dv50 is also known as the volume mean diameter (VMD) where 50% of the spray volume is less than the VMD and 50% of the spray volume is greater than the VMD.

Test results: Raw data for all droplet size tests is presented in Table 2.

TABLE 2
Droplet size test results

| | | | | | | % Drift |
|---|---|---|---|---|---|---|
| Nozzle | Mix | VMD | Vol < 100 | DV10 | DV90 | Red'n |
| AIXR | Water | 384 | 1.97 | 186 | 611 | — |
| | gly | 323 | 3.8 | 149 | 530 | — |
| | 10 | 369 | 2.97 | 167 | 610 | 22 |
| | 20 | 382 | 2.42 | 175 | 647 | 36 |
| | 30 | 393 | 2.2 | 182 | 641 | 42 |
| | 40 | 428 | 1.64 | 199 | 710 | 57 |
| | 50 | 439 | 1.55 | 204 | 725 | 59 |
| | 60 | 448 | 1.43 | 210 | 729 | 62 |
| | 80 | 543 | 0.82 | 260 | 882 | 78 |
| | 100 | 587 | 0.63 | 282 | 987 | 83 |
| | AKZ1 | 372 | 2.62 | 170 | 698 | 31 |
| | AKZ2 | 450 | 1.52 | 208 | 754 | 60 |
| | AMS | 341 | 3.57 | 155 | 579 | 6 |
| | AMS + ST | 396 | 2.24 | 181 | 658 | 41 |
| TT | Water | 269 | 8.9 | 105 | 770 | — |
| | gly | 249 | 11.3 | 94 | 470 | — |
| | 10 | 279 | 7.31 | 114 | 497 | 35 |
| | 20 | 290 | 7.94 | 111 | 493 | 30 |
| | 30 | 330 | 5.41 | 131 | 631 | 52 |
| | 40 | 341 | 4.57 | 142 | 597 | 60 |
| | 50 | 331 | 5.57 | 131 | 607 | 51 |
| | 60 | 354 | 4.5 | 144 | 607 | 60 |
| | 80 | 411 | 3.31 | 167 | 776 | 71 |
| | 100 | 433 | 2.89 | 179 | 770 | 74 |
| | AKZ1 | 288 | 8.07 | 110 | 503 | 29 |
| | AKZ2 | 356 | 5.06 | 139 | 690 | 55 |
| | AMS | 247 | 11.36 | 94 | 492 | 0 |
| | AMS + ST | 312 | 5.72 | 127 | 547 | 49 |
| XR | Water | 187 | 16.92 | 78 | 328 | — |
| | gly | 175 | 19.05 | 73 | 309 | — |
| | 10 | 194 | 15.82 | 81 | 346 | 17 |
| | 20 | 209 | 14.33 | 85 | 402 | 25 |
| | 30 | 226 | 12.57 | 90 | 457 | 34 |
| | 40 | 242 | 10.98 | 95 | 429 | 42 |
| | 50 | 275 | 9.07 | 105 | 626 | 52 |
| | 60 | 304 | 7.28 | 117 | 659 | 62 |
| | 80 | 344 | 5.54 | 133 | 853 | 71 |
| | 100 | 360 | 4.83 | 142 | 755 | 75 |
| | AKZ1 | 237 | 11.65 | 93 | 534 | 39 |
| | AKZ2 | 310 | 7.35 | 116 | 842 | 61 |
| | AMS | 176 | 19.84 | 71 | 325 | 0 |
| | AMS + ST | 221 | 12.93 | 89 | 430 | 32 |

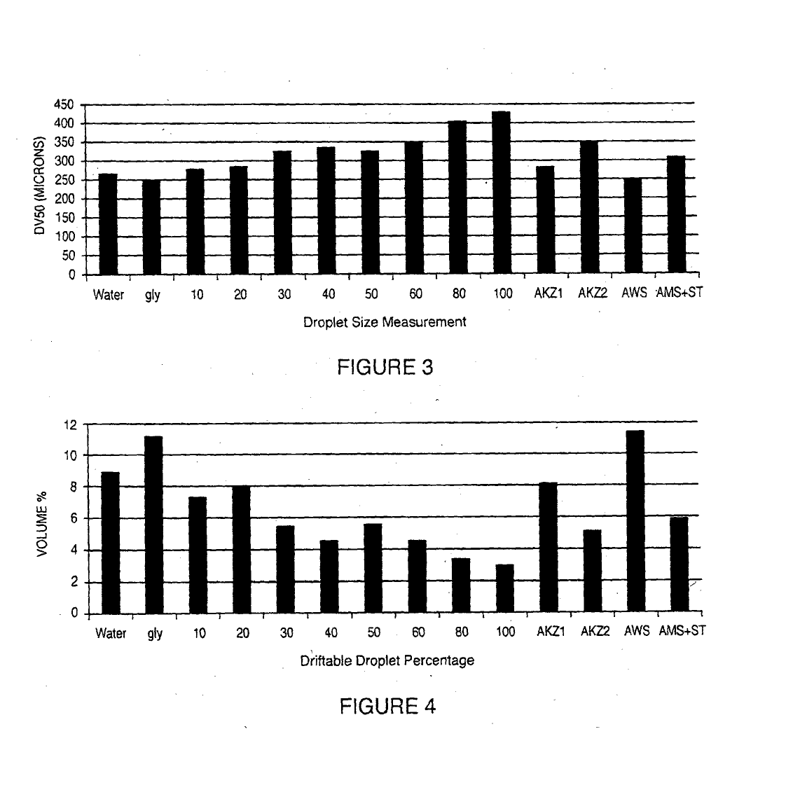

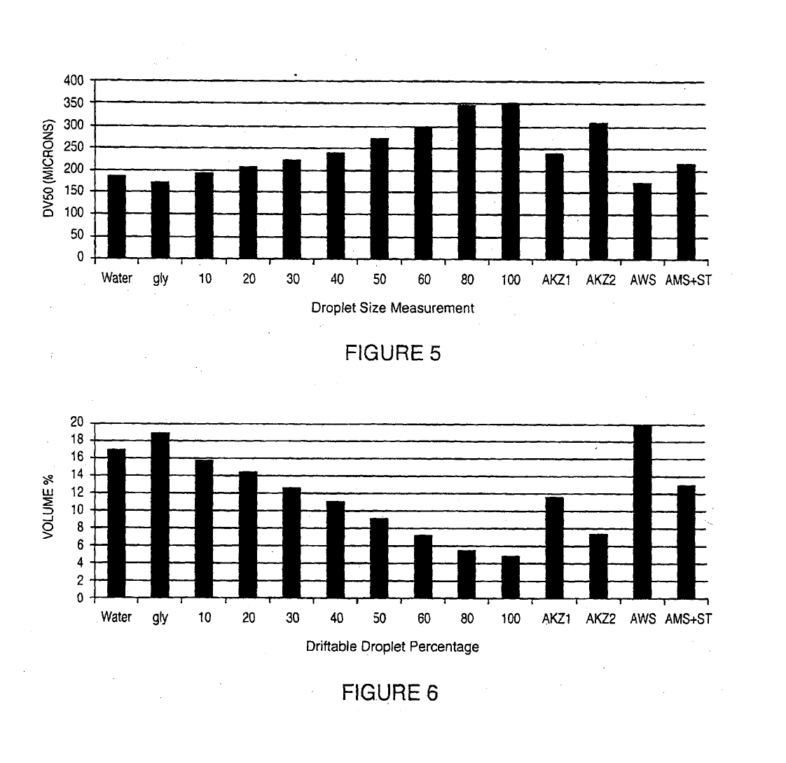

The plots depicted in FIGS. 1, 3 and 5 illustrate that the formulation according to the present invention increases the volume mean diameter (Dv50) for all concentrations and all nozzles tested when compared with the glyphosate herbicide only. Furthermore Dv50 for 30 and 60 ppm formulations of the present invention are comparable in all cases with the AKZ-1 and AKZ-2 results (Akzel-R-ate™ PAM concentration of 31 and 62 ppm respectively).

The volume of driftable spray droplets (<100 micron is reduced at all concentrations of the present formulation tested when compared with the control mix containing only 2% glyphosate and again, results for 30 and 60 ppm of the present formulation closely match the corresponding concentrations of Akzel-R-ate™. The optimum concentration range for formulations of the present invention appears to be 30 to 60 ppm given a reduction in volume of <100 micron droplets between 34 and 62% for all the nozzles tested.

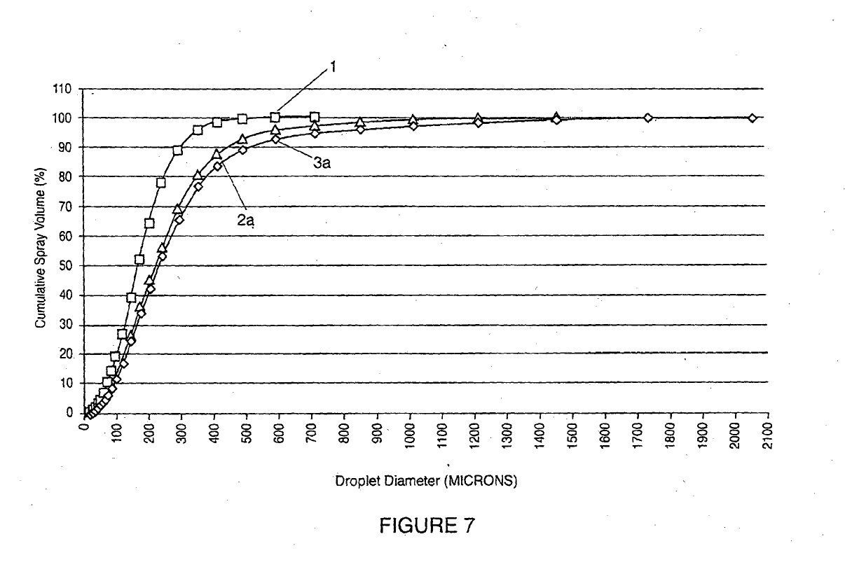

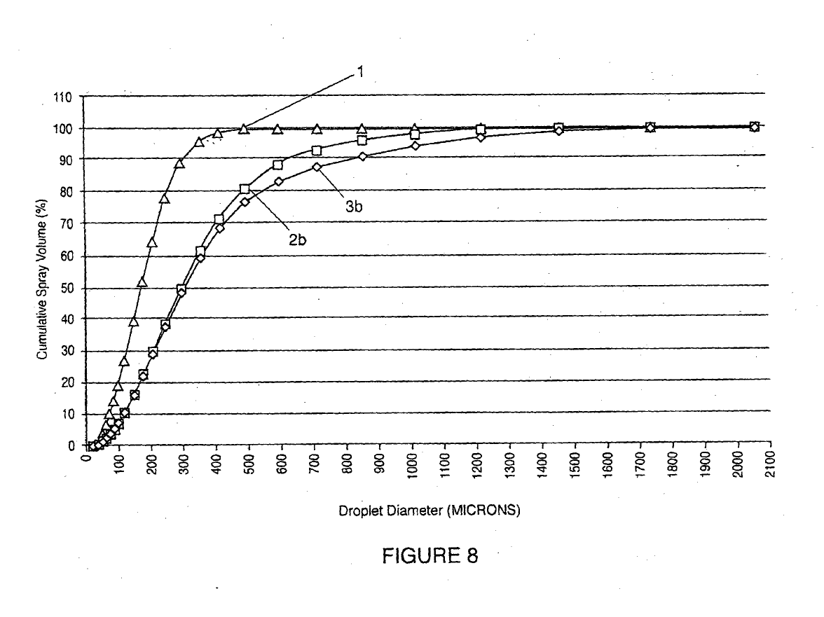

FIGS. 7 and 8 reveal that although both the formulation of the present invention and Akzel-R-ate™ formulations reduce the driftable droplets by about the same proportion, the present invention does not greatly increase the larger droplet sizes (larger than the VMD) when compared with Akzel-R-ate™ formulations. The narrower overall spectrum (as shown by the comparative Dv90's for both the formulations) means that spray coverage is less adversely affected with the present formulation than with the Akzel-R-ate™ formulation. (Results for FIG. 7 are: 2% glyphosate only Dᵥ10 73, Dᵥ50 175, Dᵥ100 309; current formulation Dᵥ10 90, Dᵥ50 226, Dᵥ90 457; Akzel-R-ate Dᵥ10 93, Dᵥ50 237, Dᵥ100 534). (Results for FIG. 8 are: 2% glyphosate only Dᵥ10 73, Dᵥ50 175, Dᵥ 309; current formulation Dᵥ10 117, Dᵥ50 304, Dᵥ100 659; Akzel-R-ate Dᵥ10 116, Dᵥ50 310, Dᵥ100 842).

Summary of Example 1 Spray Droplet Testing Results:

Spray droplet size testing was conducted at the University of Queensland (Gatton) Centre for Pesticide Application and Safety (CPAS) wind tunnel facility using laser measurements and three different nozzle types. Tests were designed to examine the performance of formulations according to the present invention over a wide range of concentrations and to obtain comparison test data using a well known commercial product of the prior art known as Akzel-R-ate™ spray drift retardant, also marketed under the trade mark Companion Gold™ in some countries such as the USA.

Test results confirm the spray drift reduction properties of formulations according to the present invention at all concentrations tested (10, 20, 30, 40, 50, 60, 80, 100 ppm). For comparison purposes Akzel-R-ate™ was tested at two concentrations (approximately 30 ppm and approximately 60 ppm PAM) representing the low and high rates recommended by the manufacturer's label for use of the product. Ammonium sulphate (AMS) is another component of the Akzel-R-ate™ formula and so measurements were also obtained for AMS and AMS plus 30 ppm of formulation according to the current invention. AMS was found to have no drift retarding properties and did not affect the performance of the formulation according to the present invention.

Using the application rates recommended by the Akzel-R-ate™ manufacturer, spray drift reductions (droplets less than 100 micron) for formulations according to the present invention ranged from 34 to 62% compared with Akzel-R-ate™ formulations which ranged from 31 to 61%.

The experimental results overall suggest the following conclusions:
(i) the presence of spray drift retardant formulations according to the present invention in spray solutions containing 2% glyphosate herbicide reduces the volume of spray droplets <100 micron by 34 to 62% at application rates of 30 to 60 ppm,
(ii) the reduction in driftable droplets using formulations according to the present invention is directly comparable to the performance of commercial Akzel-R-ate™ formulation,
(iii) the spray drift retardant formulations according to the present invention produces a narrower large-droplet size spectrum than the Akzel-R-ate™ formulation indicating that sprays with the former would have better coverage characteristics than sprays with the equivalent concentration of Akzel-R-ate™ formulation,

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A liquid spray additive composition comprising:
5 to 15 wt % of spray drift retardant having particle size of less than 150 micron, and
an effervescent couple comprising 15 to 30 wt % acid, and 30 to 50 wt % alkali,
wherein the composition is in the form of a tablet.

2. The liquid spray additive composition according to claim 1 wherein the spray drift retardant is a polymer formed from water soluble monomer or monomer blend.

3. The liquid spray additive composition according to claim 1 wherein the spray drift retardant is a non-ionic or anionic polymer containing up to 30 wt % anionic monomer components.

4. The liquid spray additive composition according to claim 1 wherein the spray drift retardant is chosen from the group comprising visco-elastic polyacrylamides, polyethylene oxides, polyvinyl pyrrolidones), guar-gum compounds, soy lecithin compounds, and cellulosic materials.

5. The liquid spray additive composition according to claim 1 wherein the spray drift retardant comprises one or more linear visco-elastic polyacryamide.

6. The spray additive composition according to claim 1 which further comprise 10 to 15 wt % of tableting aids.

7. The spray additive composition according to claim 1 which further comprises a non-ionic wetting agent.

8. The liquid spray additive composition according to claim 1 comprising:
9 to 11 wt % of at least one visco-elastic polyacrylamide having particles of <150 micron,
an effervescent couple comprising 27 to 29 wt % organic acid, and 49 to 51 wt % sodium or potassium bicarbonate,
9 to 11 wt % polyethylene glycol, and
1 to 3 wt % tableting aid
wherein the composition is in a solid dosage form.

9. The liquid spray additive composition according to claim 8 wherein the organic acid is chosen from the group comprising citric, malic, ascorbic, adipic, tartaric, fumaric or other food acids or combinations thereof.

10. The liquid spray formulation comprising:
a spray additive composition according to claim 1 in solid dosage form,
a carrier solvent, and
an active.

11. The liquid spray formulation according to claim 10 which further comprises a non-ionic wetting agent.

12. The liquid spray formulation according to claim 10 wherein the solid dosage form is a tablet.

13. The liquid spray formulation according to claim 10 wherein the active is chosen from the group comprising agricultural, horticultural, pharmaceutical or veterinary actives, or combinations thereof.

14. The method of forming a spray liquid formulation comprising the steps of:
(i) providing a tablet according to claim 1,
(ii) providing a concentrate containing an agrochemical active,
(iii) combining the tablet and concentrate with a solvent.

15. The method according to claim 14 wherein the agrochemical active is chosen from the group comprising herbicides, pesticides, fertilisers, growth promoters or other crop protection active or combinations thereof.
